(19) United States
(12) Patent Application Publication
(10) Pub. No.: US 2005/0177403 A1
(43) Pub. Date: Aug. 11, 2005

(54) System and method for measuring and controlling the quality of medical consulting reports

(76) Inventor: Thomas D. Johnson, Raleigh, NC (US)

Correspondence Address: COATS & BENNETT, PLLC, P O BOX 5, RALEIGH, NC, 27602, US

(21) Appl. No.: 10/774,652

(22) Filed: Feb. 6, 2004

(51) Int. Cl. G06F 17/60

(52) U.S. Cl. 705/7

(57) ABSTRACT

Medical consulting reports are assessed for quality with respect to a plurality of predetermined criteria. Each criterion comprises a plurality of parameters and a scoring scale relating the parameters to the report. A QA reviewer assesses the report with respect to the criteria and generates a numeric score for each criterion. The numeric scores are aggregated and statistically analyzed. In some embodiments, individual report numeric scores are not reported. Report quality data is reported in a variety of formats. Representative assessment criteria include the format of the report; the relevance of the contents of the report to the questions posed; the degree to which conclusions or opinions are supported by objective tests and observations; and the appropriate and consistent use of appropriate medico-legal terminology. The assessment is useful for controlling the overall quality of a group medical consulting reports, such as those generated for a particular customer.

### BACKGROUND

The present invention relates generally to the field of medical consulting, and in particular to a system and method for assessing the quality of medical consulting reports.

The insurance industry has an historical and ongoing need for medical consulting services to assist with objectively assessing and managing a variety of risks and transactions, such as for example processing injury related insurance claims. Medical consulting services, offering independent medical evaluations, peer reviews, and medical file reviews by medical professionals, have been developed to address this need. The product of these medical consulting services is generally a written report that may become part of an insurance claim file. The report is often a significant factor in guiding the claims examiner to make a specific decision regarding the appropriate action to take on a claim such as, for example, awarding Total or Partial Disability (Permanently or Temporarily), or denying the claim. The objectivity and overall quality of the medical consulting report is critical to ensure that appropriate and defensible decisions are made on claims. To make informed business decisions regarding the procurement of medical consulting reports, the insurance industry has an acute and ongoing need for an objective system and method of evaluating, tracking, and reporting the quality of the medical consulting reports.

### SUMMARY

The present invention relates in one aspect to a method of measuring the quality of a plurality of medical consulting reports. The method includes assessing the quality of each medical consulting report with respect to predetermined criteria to generate quantified medical consulting report quality data. The method also includes statistically analyzing the medical consulting report quality data to generate aggregate medical consulting report quality data.

In another aspect, the present invention relates to a system for assessing the quality of a plurality of medical consulting reports. The system includes a plurality of predetermined medical consulting report quality criteria, each of the criteria comprising at least one objective assessment parameter, with each parameter having an associated scoring scale. A quality assurance reviewer is operative to assess each medical consulting report with respect to each criterion, and to assign the medical consulting report numeric score for each parameter. A medical consulting report quality data management system is operative to aggregate and statistically analyze the numeric scores.

### BRIEF DESCRIPTION OF DRAWINGS

FIG. 1 is a block diagram of a medical consulting report generation transaction, depicting the quality assessment system of the present invention.

FIG. 2 is a flow diagram depicting a method of measuring the quality of a medical consulting report.

FIG. 3 is a chart depicting the aggregation and statistical analysis of medical consulting report quality data.

FIG. 4 is a representative tabular report of the weighted quality scores of a selected plurality of medical consulting report sources over a particular duration.

FIG. 5 is a representative graphic report of the weighted quality scores of a plurality of medical professionals for a particular customer over a particular duration.

### DETAILED DESCRIPTION OF THE INVENTION

Medical consulting reports are written reports (including those in electronic format) setting forth the opinions and conclusions of medical professionals regarding specific aspects of a particular individual, examination, or medical analysis. Medical consulting reports are critical to decision-making in the insurance industry. For example, a decision to award Total or Partial disability (Permanently or Temporarily) or deny a claim filed by an individual may depend almost entirely on a doctor's assessment of the individual's claimed injuries and their likely cause, as set forth in the doctor's medical consulting report. As another example, the decision whether to issue a life insurance policy to an applicant may depend largely upon an evaluation of the applicant's health, as set forth in a medical consulting report by a medical professional (not necessarily a doctor) who has examined the applicant. As yet another example, a medical consulting report may include analysis and conclusions drawn from medical records, laboratory work, genetic analysis, pathology, and the like. All such examples are illustrative only, and do not limit the present invention. In general, the term “medical consulting report” is to be construed broadly.

As with any work created by individuals, the quality of medical consulting reports varies widely. Since the medical consulting report is often the basis for business decisions having significant financial consequences, it is critical that business decisions regarding the procurement of medical consulting reports take into account the quality of the reports. However, no current system or method exists for objectively assessing and quantifying medical consulting report quality. While experienced claims examiners and other insurance industry personnel claim to “know it when they see it,” such ad hoc assessments are subjective, inconsistent and limiting in that they require extensive experience in the field and do not provide a meaningful and quantifiable comparison of medical consulting report quality between medical professionals.

However, many factors that differentiate a high quality medical consulting report from one of lower quality are known and may be objectively assessed. According to the present invention, medical consulting reports are assessed for quality according to a plurality of predetermined objective criteria. Data resulting from this assessment are managed according to the present invention, and aggregate medical consulting report quality data is reported in a variety of formats that facilitate informed business decisions on the part of medical consulting report consumers.

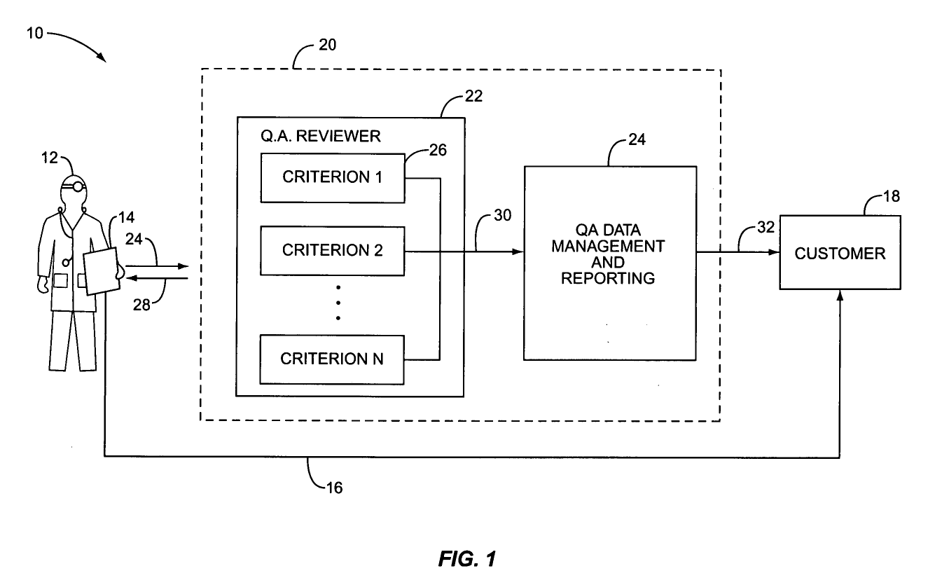

FIG. 1 depicts the medical consulting report quality assessment system 20 according to the present invention, in the context of a medical consulting report procurement transaction, indicated generally by the numeral 10. A medical professional 12, selected by a customer 18 (for example, an insurance company claims examiner), performs an examination, evaluation, assessment or other professional service, and generates a written report 14 detailing his or her conclusions and professional opinion. The medical consulting report 14 generally addresses specific questions posed by the customer 18 in a document authorizing the report 14, referred to as the cover letter. The report 14 is submitted, as indicated by arrow 16, to the customer 18. In order to assess and track the quality of medical consulting reports 14 generated by this medical professional 12, the customer 18 purchasing the report 14 may employ the quality assurance system 20 of the present invention, either directly (“in-house”), or through a third party administrator. The quality assurance (QA) system 20 comprises a QA reviewer 22 that generates QA data 30. A QA data management and reporting system 24 receives the QA data 30 for individual reports 14, and generates aggregate medical consulting report quality data 32 for the customer 18.

The QA reviewer 22 accepts the medical consulting report 14, as indicated by the arrow 24, and reviews the report 14 with respect to a plurality of predetermined criteria 26. In the event that the medical consulting report 14 is incomplete, or otherwise deficient in one or more of the quality criteria 26, requests for clarification are submitted to the medical professional 12, as indicated by the arrow 28. The medical professional 12 may then revise the medical consulting report 14, resubmit it (arrow 24) and the review is repeated. As further described herein, each of the criteria 26 against which the medical consulting report 14 is assessed are specific and objective, and results in a numerical score reflecting the quality of the medical consulting report 14 with respect to each assessed criterion 26.

These numerical scores 30 are passed to a QA data management system 24. The data management system 24 maintains and tracks a variety of data relevant to the medical consulting report 14, including the QA numeric scores 30. As explained more fully herein, the QA numeric scores 30 associated with individual medical consulting reports 14 are aggregated, and statistical analyses are performed on the aggregated QA data. Meaningful aggregate medical consulting report quality data 32 are then provided, in a variety of formats, to the customer 18, to facilitate its business decisions regarding the procurement of future medical consulting reports 14.

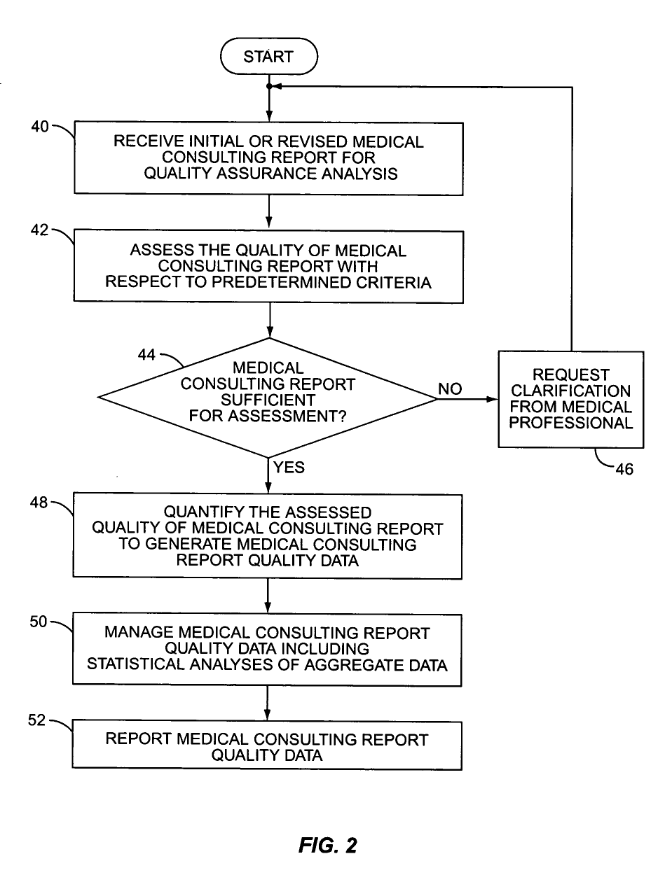

A method for measuring the quality of a plurality of medical consulting reports is depicted in flow diagram form in FIG. 2. A medical consulting report 14 is received at step 40 for a quality assurance analysis. The medical consulting report 14 is initially assessed at step 42 with respect to a plurality of predetermined criteria 26. Each criterion 26 relates to a measurable aspect of the quality of the medical consulting report 14, and is specifically defined to include objective parameters that correlate the criterion 26 to the medical consulting report 14. The parameters associated with each criterion 26 are ranked in a scoring scale, which result in a numeric score 30 being assigned to the medical consulting report 14 for each assessed criterion 26. For example and without limitation, the predetermined criteria may include the format of the medical consulting report 14; the relevance of the contents of the report 14 to the questions posed; the degree to which conclusions or opinions are supported by objective tests and observations; the appropriate and consistent use of medico-legal terminology and the like, as more fully detailed herein.

Following an initial review of the medical consulting report 14, the QA reviewer 22 may conclude, at step 44, that the medical consulting report 14 is incomplete, or otherwise deficient in one or more of the quality criteria 26. If it is determined that this is the case, the QA reviewer 22 prepares a written request for clarification from the medical professional 12, at step 46. The medical professional 12 may then revise the medical consulting report 14, and resubmit the revised report 14 at step 40.

Complete and thorough documentation throughout the QA review process ensures transparency of the interactions between the QA reviewer 22 and the medical professional 12. Transparency of communication is necessary to ensure that no inappropriate communication takes place that could unethically modify the content of the medical consulting report 14. For example, thorough documentation of any request for clarification at step 46, and the need for such clarification, ensures that the QA reviewer 22 does not coach or coerce the medical professional 12 into changing a medical opinion, or present the appearance of doing so. In general, all communications between the QA reviewer 27 and the medical professional 12, including correspondence, email, telephone calls, and personal meetings, are preferably thoroughly documented as to the time, surrounding circumstances including the need for the communication, and the substance of the discussion with respect to telephonic and personal conversations.

Following the receipt of a revised medical consulting report 14, if necessary, the QA reviewer 22 assesses the report 14 with respect to a plurality of predetermined criteria 26. A detailed explanation of representative criteria 26 follows.

Format Criterion

The Format assessment criterion concerns the readability of the medical consulting report 14 and how the information flows from the background, through the examination or analysis, to the impressions, opinions and conclusions of the medical professional 12, and to the final conclusions of the report 14. The format should provide a logical progression of facts and information that can easily be referenced by the reader. A proper report 14 format facilitates QA assessment against other criteria 26. As one example, for a certain class of medical consulting reports 14, the Format criterion may include the following parameters:
a) Introduction: The purpose of the exam including information about accepted conditions and current complaints.
b) Current History: The current mechanism of injury along with the date, immediate reaction and symptoms, and medical treatment. This parameter also includes current symptoms, including level of pain, frequency, radiation (or lack of), parathesias, numbness, swelling, instability, loss of Range of Motion (ROM), tenderness and what, if anything, alleviates the pain.
c) Work Status: The current work situation, including if the examinee is working, with or without restrictions? If not working, why?
d) Past History: A description of similar pre-existing conditions, prior surgeries, injuries or motor vehicle accidents, prior time-loss situations involving work claims or motor vehicle accidents, and a systems review including psychiatric health and current medications.
e) Socioeconomic History: A discussion of education, hobbies, off-work activities, marital status, dependents, military experience and habits associated with smoking or use of alcohol or recreational drugs.
f) Physical Exam: Discussion of the following areas, among others: range of motion, impingement signs, skin/scars/swelling, instability, reflexes, strength, sensation, pulses, discrimination testing, neurological exam and overall response to exam.
g) Imaging Studies: If any diagnostic studies were performed or provided for review, comments and/or impressions should be included.
h) Impressions: Past, pre-existing or current findings discussed in relationship to the claimed or accepted condition (are they related or not related to the event or condition).
i) Discussion: This section will be written in the format specified by the customer. It may be in a general discussion of findings or in a question and answer format.

These elements, or parameters, of the Format assessment criterion 26 will vary, depending on the nature of the medical consulting report 14 being evaluated. The above example is representative of a report 14 associated with an individual claiming a workers' compensation injury. Other specific Format criteria 26 will vary according to the nature of the medical consulting report 14 being assessed, and all are included in the scope of the present invention.

The medical consulting report 14 is evaluated with respect to each of the parameters a-i of the Format criterion 26. According to one embodiment of the present invention, a scoring scale accompanies each criterion 26. The scoring scale is used to quantify the assessed quality of the medical consulting report 14, assigning a numeric score 30 to the report 14 for each assessed criterion 26, at step 48 of FIG. 2. The scoring scale and assignment of a numeric score 30 ensure that the assessment is as objective and consistent as possible. For example, different QA reviewers 22 should be able to assess and quantify a given medical consulting report 14 with respect to any assessment criterion, and assign it the same score 30 (or scores 30 that are numerically very close). A representative scoring scale for the Format criterion 26 is presented in Table 1 below:

TABLE 1
Scoring Scale for Format Criterion

| Format | |
|---|---|
| Score | Description |
| 5 | All parameters, (a) through (i), are included and complete. |
| 4 | Key parameters* are present, but the report 14 is missing some |
| | of the other format components that would improve the |
| | readability of the report 14. |
| 3 | The report 14 contains limited information related to each key |
| | parameter* but could have included more detail. |
| 2 | All parameters are included however they are disjointed and do |
| | not flow well resulting in a report 14 that is difficult to read. |
| 1 | Any combination of key parameters* relevant to the report 14 |
| | such as b, d, f, g, h or i are missing. |
| 0 | None of the suggested parameters are included |

*Key parameters are those sections of the report 14 that provide the support and relevance to the final opinions. These may very depending on the type of exam and the questions being addressed.

Relevance Criterion

The Relevance assessment criterion 26 concerns the degree to which responses from the medical professional 12 in the medical consulting report 14 focus on addressing the questions posed by the customer 18. Excessive editorializing or straying off topic to unrelated issues is undesirable. Each question should receive a thorough response. As one example, for some medical consulting reports 14, the Relevance criterion 26 may include the following parameters:
a) Opinions or answers should be stated in direct relationship to the questions asked in the cover letter. Wherever possible and reasonable, links to other components of the report 14 and exam, if any, should be included or referenced.
b) The diagnosis should be discussed in relationship to the injury/disease based upon examinee history, physical examination and testing. Any abnormalities in symptoms, range of motion, physical abilities or other components of the exam should be explained in relationship to the condition being addressed.
c) Symptoms should be consistent with the diagnosis, with a clearly defined pathology.
d) Simple “yes” or “no” responses are appropriate occasionally, but only if it fits the specific question.
e) The discussion should explain the relevance of the exam findings, medical records and authoritative information in relationship to the impressions or diagnosis.
f) The tone of the medical consulting report 14 should be professional. It should not include sarcasm or criticize the customer 18 or the content of the cover letter. The report 14 should acknowledge the accepted condition(s) regardless of whether the medical professional 12 agrees with the condition. Evaluations should be fair and consistent.

A representative scoring scale for the Relevance criterion 26 is presented in Table 2 below:

TABLE 2
Scoring Scale for Relevance Criterion

| Relevance | |
|---|---|
| Score | Description |
| 5 | Cleary identifies all conditions and provides explanation and |
| | support for impressions or diagnosis as well as questions |
| | being addressed. |
| 4 | Very solid with respect to parameters a, b and c but the |
| | discussion does not link the relevance of physical finding, |
| | examinee history and mechanism of injury to the |
| | impressions or diagnosis. |
| 3 | Some additional conditions identified in the physical |
| | exam are not addressed in relationship to the |
| | condition being examined. However, the condition |
| | being addressed is discussed thoroughly. |
| 2 | Responses answer questions but the reader would have to |
| | search the report 14 for relevant supporting information. |
| 1 | Diagnosis is made without indication of the relationship to the |
| | condition in question, and no other reference is available |
| | elsewhere in the report 14 to help clarify. Answers do not |
| | address the questions being asked |
| 0 | The report 14 meets none of the required parameters. |

Support Criterion

The Support assessment criterion 26 concerns the degree to which responses from the medical professional 12 in the medical consulting report 14 are supported by objective tests or observations when possible. Statements that reach a conclusion with no clear path as to how the conclusion was reached create a report 14 of poor quality, even if the conclusions are accurate. As one example, for some medical consulting reports 14, the Support criterion 26 may include the following parameters:
a) Each response is clear in reasoning and can easily be linked to other information in the report 14.
b) The report 14 is strengthened by an effective choice of words.
c) The medical professional 12 supports responses by referencing or paraphrasing from other sections of the report 14.
d) The medical opinion is supported with the use of current medical journals or recently written articles if applicable.

A representative scoring scale for the Support criterion 26 is presented in Table 3 below:

TABLE 3
Scoring Scale for Support Criterion

| Support | |
|---|---|
| Score | Description |
| 5 | The report 14 has all the required support parameters. |
| 4 | The report 14 answers questions directly and appropriate |
| | supporting information is used or referenced. The report 14 |
| | could be stronger with a stronger choice of words. |
| 3 | Answers to questions are weakly worded, but the remainder of |
| | the report 14 is strong. |
| 2 | Answers to questions are brief and without supporting |
| | information, but there is supporting information in |
| | other portions of report 14. |
| 1 | Answers to questions are brief with no support elsewhere in the |
| | report 14. |
| 0 | The report 14 has none of the required parameters. |

Medico-Legal Context Criterion

The Medico-Legal Context assessment criterion 26 concerns the degree to which the medical consulting report 14 utilizes appropriate medical and legal terminology. Since medical consulting reports 14 are used as a basis for decisions in the claims environment, the appropriate legal perspective must be considered. As one example, for some medical consulting reports 14, the Medico-Legal Context criterion 26 may include the following parameters:
a) The report 14 should state each conclusion using appropriate language from the relevant cover letter question. Terms such as “more probable than not” and “within all reasonable medical probability” add strength to the response.
b) All legal criteria must be met in order for the claims adjuster to move forward with the claim. Addressing answers using the same technical terminology used in the question, such as “medically stationary,” “maximum medical improvement” or “pre-existing underlying condition” are medical-legal terms that are needed to meet the rules and regulation governing the claim being addressed.

A representative scoring scale for the Medico-Legal Context criterion 26 is presented in Table 4 below:

TABLE 4
Scoring Sale for Medico-Legal Context Criterion

| Medico-Legal | |
|---|---|
| Context | |
| Score | Description |
| 5 | Questions, answers and discussion are developed using |
| | the appropriate medico-legal language necessary to |
| | address the type of claim being addressed. |
| 4 | The report 14 discussion uses correct medico-legal |
| | terminology, but in the questions and answer section |
| | it is not used in answers at all. Answers are |
| | responsive to the question, but do not include |
| | medico-legal terms. |
| 3 | Answers are directly related to the question, but the |
| | medico-legal terminology used is not clear or complete. |
| | Responses are not consistent with the discussion or |
| | from prior responses to questions. |
| 2 | Responses answer the questions, but the medico-legal |
| | terminology is misused or is not addressing all the |
| | medico-legal requirements to enable the adjuster to |
| | move forward with the claim. |
| 1 | Responses are weak and are made without regard for |
| | necessary terminology to clearly meet medico-legal |
| | requirements. |
| 0 | The report contains none of the required parameters. |

The quality of the medical consulting report 14 is quantified with respect to each assessment criterion (e.g., Format, Relevance, Support, Medico-Legal Context, and any additional criteria relevant to a particular report 14), and assigned an objective numeric score 30 with respect to each assessed criterion 26 at step 48 of FIG. 2. Preferably, the QA reviewer(s) 22 do not determine a final quality score for the medical consulting report 14, but rather score only the individual criteria 26 used to assess the report 14. The objectivity of quality ratings is improved if QA personnel limit their quality analysis of the report 14 to specific, defined criteria 26. This improves the repeatability and consistency of the quality scoring.

The same individual may score a given medical consulting report 14 against all relevant assessment criteria 26, or alternatively, different individuals may score the report 14 for some or all of the different criteria 26. The same or very similar numeric scores 30 should result in either case. This is a feature of the objectivity of the scoring matrices of the present invention. While scoring by humans is presently contemplated, it is possible that future advances in computer science and artificial intelligence may allow medical consulting reports 14 to be QA reviewed by assessment against criteria 26, generating numeric scores 30, automatically, such as by computer. Such automatic QA review would be within the scope of the present invention.

To provide the customer with useful information regarding the quality of reviewed medical consulting reports 14, the numeric score data 30 and other data relating to the reports 14 are managed at step 50 of FIG. 2. Management of quality data preferably comprises aggregating the numeric score data 30 from a selected plurality of medical consulting reports 14, and performing statistical analyses on the aggregated data.

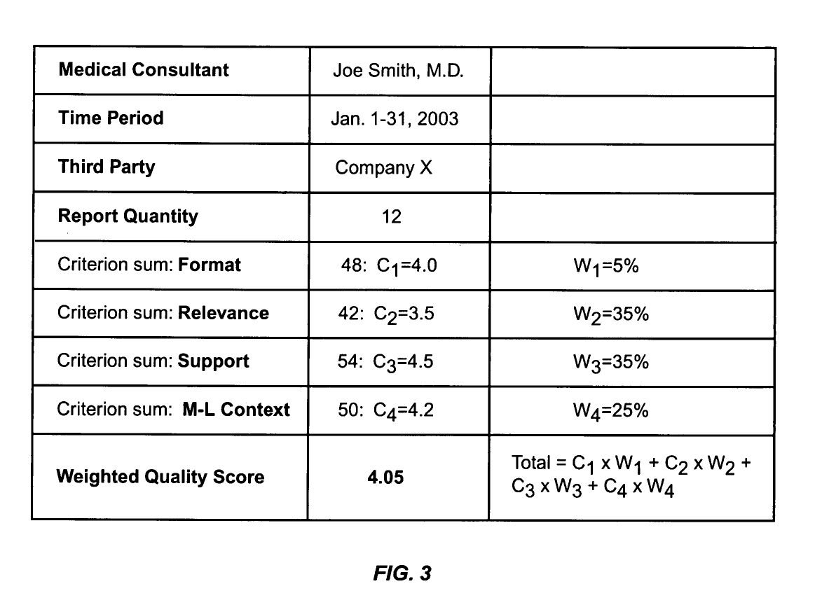

For example, FIG. 3 demonstrates the aggregation and analysis of quality data of all of the medical consulting reports 14 generated by a particular medical professional 12 (Joe Smith, M.D.) over a specific time period (Jan. 1-31, 2003) for a particular customer 18 (Company X). The number of reports 14 in this subset is twelve. The numeric scores 30 for each assessment criterion 26, for each of the twelve medical consulting reports 14, are added to generate total scores, or sums, for each criterion (Format: 48, Relevance: 42, Support: 54, and M-L Context: 50). These total scores are divided by the number of medical consulting reports 14 reviewed (twelve) to generate average criteria scores (C1=4.0, C2=3.5, C3=4.5 and C4=4.2). A weighting factor W is assigned to each criterion 26. This weighting factor reflects the relative importance attached by the customer 18 to each of the assessment criteria 26 (in this example, W1=5%, W2=35%, W3=35% and W4=25%). The weighting factors may be assigned any relative value (including zero), however, note that the weighting factors should add up to 100% (to maintain the resulting weighted quality score in the same 0-5 range as the numeric scores 30 of the individual medical consulting reports 14). Finally, the weighted quality score (4.05) is determined by multiplying the average score for each assessment criterion 26 by the weighting factor for that criterion 26, and adding the resulting products for all criteria 26, according to the formula shown in FIG. 3.

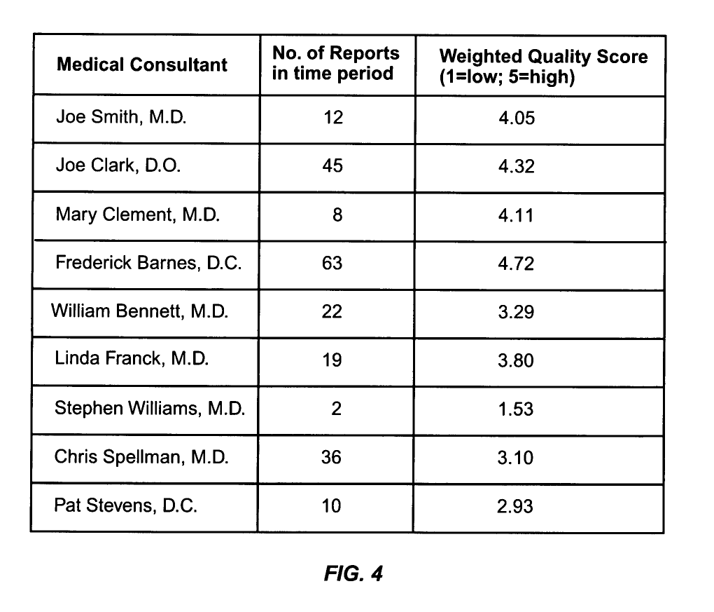

This weighted quality score may be reported to the customer 18 at step 52 of FIG. 2. The weighted quality score is indicative of the quality of medical consulting reports 14 generated by this particular medical professional 12 over the specified time period, with respect to the customer's weighting of the assessment criteria 12. The customer may advantageously utilize this score in ranking the medical professional 12 in its internal list of preferred providers of medical consulting reports 14, in negotiating fees with the medical professional 12, or for other business purposes. FIG. 4 depicts a representative tabular report of the weighted quality scores of selected medical professionals 12 over a particular time period, as generated by the present invention.

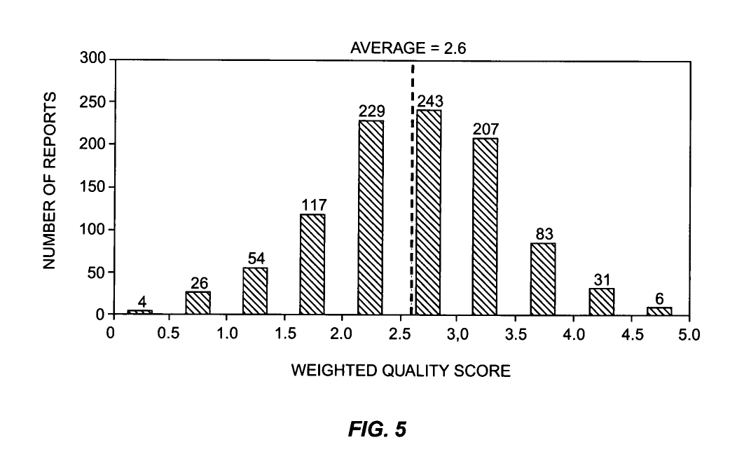

The data may be subjected to further statistical analyses, as well known by those of skill in the art. For example, FIG. 5 depicts a distribution curve for the weighted quality scores of a large number of medical consulting reports 14 generated by numerous medical professionals 12 for a particular customer 18, with bars representing the combined distribution of weighted quality scores falling with a one-half score range or “bin.” In this example, the graph approximates a Gaussian distribution (or “bell curve”), with a mean value of 2.6.

Note that in the graph of FIG. 5, each medical professional is represented in only one bin. For example, referring to FIGS. 3 and 4, medical professional Joe Smith, M.D. generated twelve medical consulting reports for Company X during January, 2003, for a weighted quality score of 4.05. If FIG. 5 is a graph of the total medical consulting reports generated for Company X during January, 2003 (of which FIG. 4 is a partial listing), Joe Smith's reports comprise twelve of the thirty-one reports that received a weighted quality score between 4.0 and 4.5. According to the present invention, an entity—such as the customer 18 or a third party providing medical consulting report services to the customer 18—may improve the overall quality of medical consulting reports generated for the customer 18 over time by using the weighted quality scores to select medical professionals 12. For example, the medical professionals 12 with weighted quality scores below 1.5, i.e., all of those in the first three bins of the graph of FIG. 5, may be excluded from future medical consulting report business, and those reports solicited instead from individuals having higher weighted quality scores. This business decision will increase both the mean and median weighted quality score for all reports generated for the customer. In this manner, the quality assessment system and method of the present invention is useful to not only analyze, but to control, the quality of medical consulting reports.

Note that the numeric scores 30 for individual medical consulting reports 14 are indicative only of the quality of the report 14 as defined by the criteria 26—they convey no information about the quality of the underlying medical opinion contained in the report 14. In cases where claims decisions are disputed, the medical consulting report 14 may be utilized in subsequent litigation. Due to the possibility that a low quality score may be used to inaccurately disparage the medical opinion stated a medical consulting report 14 (as opposed to the quality of the report 14 itself based on the quality criteria 26), according to one embodiment of the present invention, individual report 14 QA numeric scores 30 are never reported. That is, only aggregate scores, such as those calculated by the method of FIG. 3 above, are retained and reported to the customer.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

1. A method of measuring the quality of a plurality of medical consulting reports, comprising:
assessing the quality of each said medical consulting report with respect to predetermined criteria to generate quantified medical consulting report quality data; and
statistically analyzing said medical consulting report quality data to generate aggregate medical consulting report quality data.

2. The method of claim 1 wherein said predetermined criteria include the report format.

3. The method of claim 1 wherein said predetermined criteria include the relevance of the report to the medical questions it addresses.

4. The method of claim 1 wherein said predetermined criteria include objective support in the report for the conclusion(s) reached.

5. The method of claim 1 wherein said predetermined criteria include the use of medico-legal terminology.

6. The method of claim 1 wherein assessing the quality of each said medical consulting report comprises scoring the report for each assessed predetermined criterion according to a specific, objective scoring scale unique to that predetermined criterion.

7. The method of claim 6 wherein scoring the report for each assessed predetermined criterion comprises assigning a point total to the report representative of the assessment with respect to that predetermined criterion.

8. The method of claim 7 wherein said point total ranges from 0 to 5.

9. The method of claim 7 wherein statistically analyzing said medical consulting report quality data includes summing said point totals for each assessed predetermined criterion for a selected plurality of said medical consulting reports.

10. The method of claim 9 wherein said statistical analyses further include dividing said summed point totals by the number of said selected plurality of said medical consulting reports to generate an average score for each predetermined criterion.

11. The method of claim 10 wherein statistically analyzing said medical consulting report quality data further includes weighting each said predetermined criterion by a weighting factor, the weighting factors for all assessed predetermined criteria totaling 100.

12. The method of claim 11 wherein statistically analyzing said medical consulting report quality data further includes generating a weighted average score for each assessed predetermined criterion by multiplying said average score for each predetermined criterion by the corresponding said weighting factor.

13. The method of claim 12 wherein statistically analyzing said medical consulting report quality data further includes generating a weighted quality score for said selected plurality of said medical consulting reports by summing said weighted average scores for each assessed predetermined criterion.

14. The method of claim 1 further comprising reporting said aggregate medical consulting report quality data in tabular format.

15. The method of claim 14 wherein reporting said aggregate medical consulting report quality data comprises reporting said aggregate quality data for reports generated by each of a selected plurality of specific medical consultants.

16. The method of claim 1 further comprising reporting said aggregate medical consulting report quality data in graphic format.

17. The method of claim 16 wherein reporting said aggregate medical consulting report quality data comprises generating a medical consulting report quality distribution curve for medical consulting reports generated by said selected medical consultants.

18. The method of claim 1 further comprising deleting, without reporting, said medical consulting report quality data relating to individual medical consulting reports, following said analyzing step.

19. The method of claim 1 wherein assessing the quality of each said medical consulting report comprises communicating with the generator of a said medical report when said medical report contains insufficient information for a meaningful quality assessment, and documenting all said communication with said generator of a medical report to ensure transparency of communication.

20. A system for assessing the quality of a plurality of medical consulting reports, comprising:
a plurality of predetermined medical consulting report quality criteria, each said criterion comprising at least one objective assessment parameter, each said parameter having an associated scoring scale;
a quality assurance reviewer operative to assess each medical consulting report with respect to each said criterion, and to assign said medical consulting report numeric score for each said parameter; and
a medical consulting report quality data management system operative to aggregate and statistically analyze said numeric scores.

21. The system of claim 20 wherein said quality assurance reviewer is a human.

22. The system of claim 20 wherein said quality assurance reviewer is a computer system.

23. The system of claim 20 wherein aggregating said numeric scores comprises averaging said numeric scores, for a particular subset of said plurality of medical consulting reports.

24. The system of claim 20 wherein statistically analyzing said numeric scores includes weighting the average numeric score for each said criterion over a specific subset of said medical consulting reports by a predetermined weighting factor, and summing the weighted average numeric scores to generate a single weighted quality score for said subset of reports.

25. The system of claim 20 further comprising a reporting system operative to report medical consulting report quality data analyzed by said management system.

26. The system of claim 25 wherein only aggregated medical consulting report quality data is reported.

27. The system of claim 20 further comprising:
a medical professional selection unit that utilizes said statistical analysis to select medical professionals for the generation of future medical consulting reports.

28. A method of ensuring transparency of communication between a medical professional generating a medical consulting report and a QA reviewer assessing the quality of the medical consulting report, comprising:
receiving an initial medical consulting report from the medical professional;
initially assessing said initial medical consulting report with respect to predetermined criteria to determine the sufficiency of said medical consulting report;
requesting additional information from the medical professional if said medical consulting report is insufficient;
receiving a revised medical consulting report from the medical professional;
documenting all communications with the medical professional;
assessing said revised medical consulting report with respect to predetermined criteria to generate quantified medical consulting report quality data; and
statistically analyzing said medical consulting report quality data, along with medical consulting report quality data from other medical consulting reports, to generate aggregate medical consulting report quality data.

29. A method of controlling the quality of a medical consulting report program, comprising:
assessing the quality of each of a plurality of medical consulting reports with respect to predetermined criteria to generate quantified medical consulting report quality data;
statistically analyzing said medical consulting report quality data to generate aggregate medical consulting report quality data, and
in response to said aggregate medical consulting report quality data, selecting medical professionals to generate future medical consulting reports so as to improve said aggregate medical consulting report quality data.
